(19) United States
(12) Patent Application Publication
(10) Pub. No.: US 2019/0188500 A1
(43) Pub. Date: Jun. 20, 2019

(54) APPARATUS FOR MONITORING OBJECT IN LOW LIGHT ENVIRONMENT AND MONITORING METHOD THEREOF

(71) Applicant: Hua-chuang Automobile Information Technical Center Co., Ltd., New Taipei City (TW)

(72) Inventors: Yen-Lin Chen, New Taipei City (TW); Chao-Wei Yu, New Taipei City (TW); Ko-Feng Lee, New Taipei City (TW); Hong-Yi Liang, New Taipei City (TW); Guang-Kai Liao, New Taipei City (TW); Yuan-Chun Chen, New Taipei City (TW); Che Wang, New Taipei City (TW)

(21) Appl. No.: 15/969,127

(22) Filed: May 2, 2018

(30) Foreign Application Priority Data
Dec. 18, 2017 (CN) 201711442626.8

(51) Int. Cl. G06K 9/00; G08G 1/052; G06K 9/46; G06T 7/246

(52) U.S. Cl. CPC G06K 9/00805; G08G 1/052; G06T 2207/30261; G06T 7/248; G06K 9/4647

(57) ABSTRACT

An apparatus for monitoring an object in a low light environment includes an image capturing unit, a vehicle speed unit, an image recognizing unit, and an object determining unit. The image capturing unit continuously captures and outputs time-sliced images. The vehicle speed unit detects and outputs current vehicle speed information. The image recognizing unit recognizes a region having pixel brightness higher than a threshold in each of the time-sliced images and marks the region as a high brightness block. The object determining unit selects at least two successive time-sliced images having high brightness blocks in a continuous corresponding variation relationship from the time-sliced images, generates and outputs estimated speed information, and when the estimated speed information is different from the current vehicle speed information, determines that the high brightness block is a moving object block and monitors the moving object block.

### CROSS-REFERENCE TO RELATED APPLICATION

This non-provisional application claims priority under 35 U.S.C. § 119(a) to Patent Application No. 201711442626.8 filed in China, P.R.C. on Dec. 18, 2017, the entire contents of which are hereby incorporated by reference.

### BACKGROUND

### Technical Field

The present invention relates to the field of vehicles, and in particular, to an apparatus for monitoring an object in a low light environment and a monitoring method thereof.

### Related Art

An existed self-driving system performs driving positioning using a global positioning system, and monitors a surrounding environment of a vehicle and a traffic condition around the vehicle according to monitored data captured by an environmental sensor, such as a visual monitor, so as to control operations, such as driving, acceleration and deceleration, turning, and gear shifting, and ensure driving safety.

However, when the visual monitor is under a dim light, mistaken determining may be easily caused due to insufficient contrast of an image. For example, a moving vehicle nearby is determined as a traffic sign. When a traffic condition around the vehicle is mistakenly determined, in particular, during lane changing, safety of the vehicle and life safety of a passenger would be endangered.

### SUMMARY

To resolve the problems in the prior art, an apparatus for monitoring an object in a low light environment is provided herein. The apparatus for monitoring an object in a low light environment includes an image capturing unit, a vehicle speed unit, an image recognizing unit, and an object determining unit. The image capturing unit continuously captures and outputs a plurality of time-sliced images. The vehicle speed unit detects and outputs current vehicle speed information. The image recognizing unit is communicably connected to the image capturing unit and receives the time-sliced images. The image recognizing unit recognizes a region having pixel brightness higher than a threshold in each of the time-sliced images and marks the region as a high brightness block. The object determining unit is communicably connected to the vehicle speed unit and the image recognizing unit and receives the current vehicle speed information and the high brightness blocks of the time-sliced images. The object determining unit selects by screening at least two successive time-sliced images having the high brightness blocks in a continuous corresponding variation relationship from the time-sliced images and generates and outputs estimated speed information according to continuous corresponding variations of the high brightness blocks of the two successive time-sliced images. When the estimated speed information is different from the current vehicle speed information determined by the object determining unit, the high brightness block is determined correspondingly as a moving object block.

In some embodiments, when the estimated speed information equals the current vehicle speed information, the object determining unit determines that the high brightness block is correspondingly a fixed object block.

In some embodiments, each of the time-sliced images includes a sky image, a road image, and a ground image, the road image is between the sky image and the ground image, and the image recognizing unit recognizes a region having pixel brightness higher than the threshold in the road image of each of the time-sliced images and marks the region as the high brightness block. Further, the road image of each of the time-sliced images includes a central image and an inner-side image. The central image is adjacent to a side of the inner-side image, and the image recognizing unit recognizes a region having pixel brightness higher than a threshold in the central image of each of the time-sliced images and marks the region as a high brightness block. Still further, each of the time-sliced images further includes an outer-side image, the outer-side image is adjacent to a side of the central image and is opposite to the inner-side image, and the image recognizing unit recognizes a region having pixel brightness higher than the threshold in the outer-side image of each of the time-sliced videos and marks the region as the high brightness block.

In some embodiments, the apparatus for monitoring an object in a low light environment further includes a grayscale conversion unit. The grayscale conversion unit is communicably connected to the image capturing unit and the image recognizing unit, the grayscale conversion unit receives the time-sliced images, converts each of the time-sliced images into a grayscale time-sliced image, and further outputs the grayscale time-sliced image to the image recognizing unit, and the image recognizing unit recognizes and marks the high brightness block according to each of the grayscale time-sliced images.

In some embodiments, the two successive time-sliced images respectively include two adjacent high brightness blocks, and the object determining unit further determines that there is a transverse spacing between the two adjacent high brightness blocks, and when the two adjacent high brightness blocks transversely continuously correspondingly vary between the at least two successive time-sliced images, pairs and integrates the two adjacent high brightness blocks into a pair of high brightness blocks.

In some embodiments, the two successive time-sliced images having the high brightness blocks in a continuous corresponding variation relationship means that a relative position, relative brightness, a block size, or a combination thereof of each of the high brightness blocks has a continuous corresponding variation.

In some embodiments, the object determining unit further generates and outputs relative position information according to continuous corresponding variations of the high brightness blocks of the two successive time-sliced images.

A method for monitoring an object in a low light environment is further provided therein, including an image capturing step, an image recognizing step, an image analyzing step, a comparing and determining step, and a monitoring step. The image capturing step is continuously capturing a plurality of time-sliced images. The image recognizing step is performing image recognition to find a region having pixel brightness higher than a threshold in each of the time-sliced images and marking the region as a high brightness block. The image analyzing step is selecting by screening at least two successive time-sliced images having the high brightness blocks in a continuous corresponding variation relationship from the time-sliced images and generating and outputting estimated speed information according to continuous corresponding variations of the high brightness blocks of the successive time-sliced images. The comparing and determining step is comparing the estimated speed information with current vehicle speed information, and when the estimated speed information is different from the current vehicle speed information, determining that the high brightness block is correspondingly a moving object block. The monitoring step is continuously monitoring the moving object block and the estimated speed information corresponding thereto.

In some embodiments, when the estimated speed information equals the current vehicle speed information, it is determined that the high brightness block is correspondingly a fixed object block, and the monitoring is stopped.

In some embodiments, each of the time-sliced images includes a sky image, a road image, and a ground image, the road image is between the sky image and the ground image, and the image recognizing step is performing image recognition to find a region having pixel brightness higher than the threshold in the road image of each of the time-sliced images and marking the region as the high brightness block. Still further, the road image of each of the time-sliced images includes a central image and an inner-side image, the central image is adjacent to a side of the inner-side image, and the image recognizing step is performing image recognition to find a region having pixel brightness higher than the threshold in the central image of each of the time-sliced images and marking the region as the high brightness block. Still further, each of the time-sliced images further includes an outer-side image, the outer-side image is adjacent to a side of the central image and is opposite to the inner-side image, and the image recognizing step is further performing image recognition to find a region having pixel brightness higher than the threshold in the outer-side image of each of the time-sliced images and marking the region as the high brightness block.

In some embodiments, the image recognizing step of the method for monitoring an object in a low light environment includes a grayscale converting step, where grayscale conversion is performed on each of the time-sliced images to obtain and output a grayscale time-sliced image; and image recognition is performed to find a region having pixel brightness higher than a threshold in each of the grayscale time-sliced images, to mark the region as a high brightness block.

In some embodiments, when it is marked that the two successive time-sliced images respectively have two adjacent high brightness blocks, the image recognizing step further includes a determining step: determining that there is a transverse spacing between the two adjacent high brightness blocks and the two adjacent high brightness blocks transversely continuously correspondingly vary between the two successive time-sliced images; and a pairing step: pairing and integrating the two adjacent high brightness blocks into a pair of high brightness blocks.

In some embodiments, the two successive time-sliced images having the high brightness blocks in a continuous corresponding variation relationship means that a relative position, relative brightness, a block size, or a combination thereof of each of the high brightness blocks has a continuous corresponding variation.

In some embodiments, the method for monitoring an object in a low light environment further includes the following step: generating and outputting relative position information according to continuous corresponding variations of the high brightness blocks of the two successive time-sliced images and continuously monitoring the relative position information.

As stated above, by capturing a high brightness block in a time-sliced image, existing visual monitoring may be replaced by light monitoring at night or in a dim light. A traffic condition of a moving object nearby a vehicle is monitored in real time, to keep vehicle driving safety, so as to implement the function of helping monitoring an environment around the vehicle all day.

The present invention is described below in detail with reference to the accompanying drawings and specific embodiments, but is not limited thereto.

### BRIEF DESCRIPTION OF THE DRAWINGS

FIG. 1 is a schematic block diagram of an apparatus for monitoring an object in a low light environment;

FIG. 2 is a schematic diagram of a time-sliced image captured by an image capturing unit;

FIG. 3 is a schematic diagram of successive time-sliced images, selected by screening by an object determining unit from time-sliced images, having high brightness blocks in a continuous corresponding variation relationship;

FIG. 4 is a schematic diagram of integrating two adjacent high brightness blocks into a pair of high brightness blocks; and

FIG. 5 is a flowchart of a method for monitoring an object in a low light environment.

### DETAILED DESCRIPTION

The structural principle and working principle of the present invention are described below in detail with reference to the accompanying drawings.

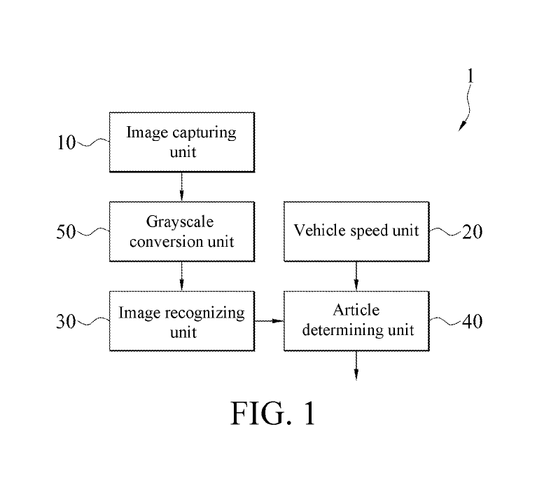

FIG. 1 is a schematic block diagram of an apparatus for monitoring an object in a low light environment. As shown in FIG. 1, an apparatus 1 for monitoring an object in a low light environment is disposed on a vehicle and includes an image capturing unit 10, a vehicle speed unit 20, an image recognizing unit 30, and an object determining unit 40. The image capturing unit 10 continuously captures and outputs a plurality of time-sliced images. The vehicle speed unit 20 detects and outputs current vehicle speed information. The image recognizing unit 30 is communicably connected to the image capturing unit 10 and receives the time-sliced images. The image recognizing unit 30 recognizes a region having pixel brightness higher than a threshold in each of the time-sliced images and marks the region as a high brightness block. The object determining unit 40 is communicably connected to the vehicle speed unit 20 and the image recognizing unit 30 and receives the current vehicle speed information and the high brightness blocks of the time-sliced images. The object determining unit 40 selects by screening a plurality of successive time-sliced images having the high brightness blocks in a continuous corresponding variation relationship from the time-sliced images and generates and outputs estimated speed information according to continuous corresponding variations of the high brightness blocks of the successive time-sliced images. When the estimated speed information is different from the current vehicle speed information determined by the object determining unit 40 determines that the high brightness block is determined correspondingly as a moving object block and continuously monitors the moving object block and estimated speed information corresponding thereto.

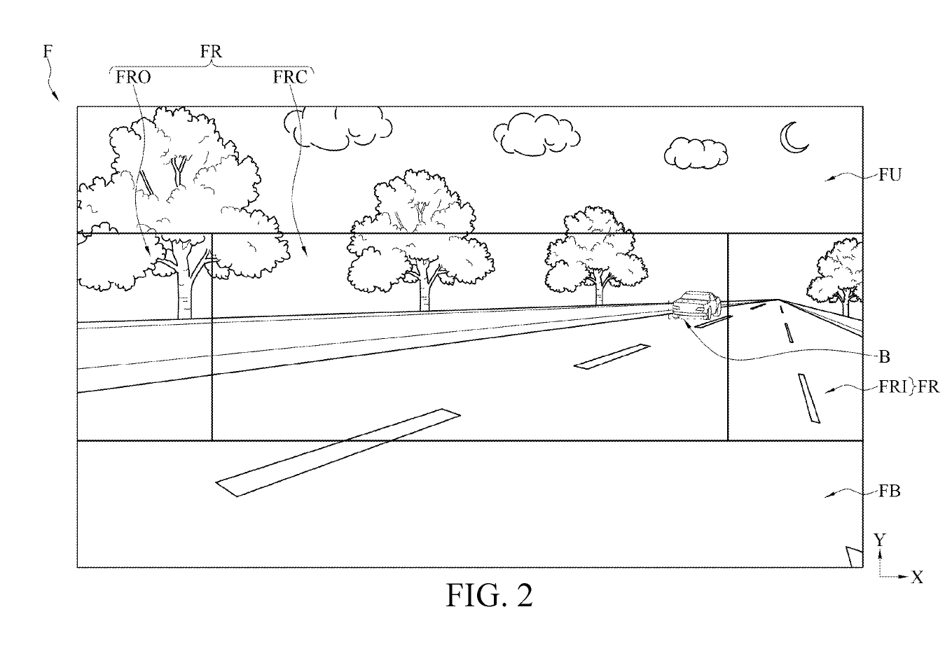

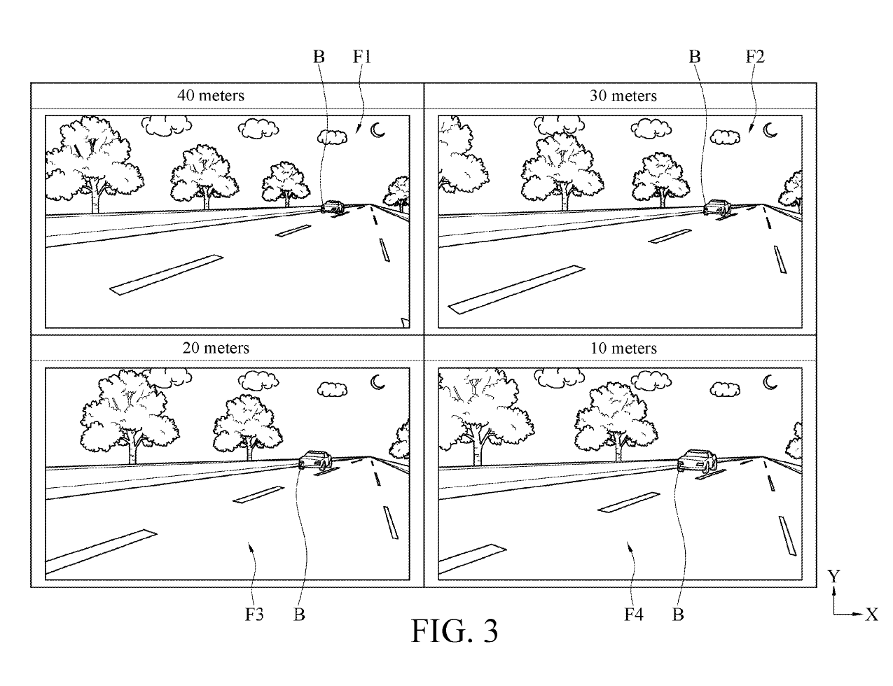

FIG. 2 is a schematic diagram of a time-sliced image captured by an image capturing unit. FIG. 3 is a schematic diagram of successive time-sliced images, selected by screening by an object determining unit from time-sliced images, having high brightness blocks in a continuous corresponding variation relationship. Herein, the so-called “low light” indicates that the environmental brightness ranges from 0 to 40 lumens, a time-sliced image may be a time-sliced image F as shown in FIG. 2, which, however, is merely an example, and actually, there should be a plurality of time-sliced images. The successive time-sliced images are successive time-sliced images F1, F2, F3, and F4 as shown in FIG. 3. A high brightness block is like a high brightness block B marked in the time-sliced image F in FIG. 2 and the successive time-sliced images F1, F2, F3, and F4 in FIG. 3. In the following description, according to the examples in FIG. 2 and FIG. 3, the time-sliced image is marked with F, the successive time-sliced images are marked with F1, F2, F3, and F4, and the high brightness block is marked with B. However, it could be understood that the above are merely examples rather than limitations.

In addition, continuous corresponding variations of the high brightness blocks B of the successive time-sliced images F1, F2, F3, and F4 mean that there is a high brightness block B in each of the successive time-sliced images F1, F2, F3, and F4, and the high brightness blocks B correspond to each other in the successive time-sliced images F1, F2, F3, and F4, that is, the high brightness blocks B can represent a same object. Furthermore, the high brightness blocks B in the successive time-sliced images F1, F2, F3, and F4 have a continuous variation relationship, for example, continuous corresponding variations of positions, continuous corresponding variations of block sizes, continuous variations of brightness, or a combination thereof.

On the contrary, when the estimated speed information equals the current vehicle speed information, the object determining unit 40 determines that the high brightness block B is correspondingly a fixed object block such as a road lamp or a stall. Generally, the fixed object block is no longer monitored. However, in a special situation, for example, there is a fire, or a road warning is received, the fixed object block can still be continuously monitored.

Hereafter, the vehicle speed unit 20 may be connected to a Controller Area Network BUS (CANBUS) of the vehicle, to capture current vehicle speed information of the vehicle. The image capturing unit 10 may be a plurality of cameras, such as a front view camera, a side view camera, a side rear view camera, and a rear view camera, around a vehicle body. The time-sliced image F and the successive time-sliced images F1, F2, F3, and F4 shown in FIG. 2 and FIG. 3 are captured by the side rear view camera, which are merely examples herein rather than limitations. As shown in FIG. 2, the time-sliced image F includes a sky image FU, a road image FR, and a ground image FB. The road image FR is between the sky image FU and the ground image FB. The image recognizing unit 30 recognizes a region having pixel brightness higher than a threshold in the road image FR of the time-sliced image F and marks the region as the high brightness block B. That is, determining performed on the high brightness block B in the road image FR, related to the vehicle driving, in the image is emphasized, to improve calculation efficiency and a determining speed.

Further, the road image FR of the time-sliced image F includes a central image FRC and an inner-side image FRI. The central image FRC is adjacent to a side of the inner-side image FR. The image recognizing unit 30 recognizes a region having pixel brightness higher than a threshold in the central image FRC of the time-sliced image F and marks the region as the high brightness block B. In FIG. 2, herein, the central image FRC corresponds to an adjacent lane region, the inner-side image FRI corresponds to a vehicle body region, which, however, is also an image captured by a side rear view camera. The above are examples rather than limitations. For example, if the front view camera is used for image capturing, the central image FRC may be a driving lane region, and the inner-side image FRI may alternatively be a partial region close to the driving lane. The central image FRC and the inner-side image FRI are provided to recognize whether there is a coming vehicle on the adjacent lane, to help determine during lane changing. In addition, the region for determining the high brightness block B may be reduced into the central image FRC, to accelerate calculating and determining.

Further, the road image FR of the time-sliced image F further includes an outer-side image FRO. The outer-side image FRO is adjacent to a side of the central image FRC and is opposite to the inner-side image FRI. The image recognizing unit 30 further recognizes a region having pixel brightness higher than a threshold in the outer-side image FRO of the time-sliced image F and marks the region as the high brightness block B. As shown in FIG. 2, the outer-side image FRO and the inner-side image FRI respectively correspond to two sides of the adjacent lane region. Herein, whether there is a moving object, such as an automobile or a motor cycle, on an outer-side lane is mainly determined, and a traffic condition thereof is monitored, to prevent an accident during lane changing, or when the moving object moves toward the vehicle, the vehicle can be controlled in time to prevent collision. However, the above are merely examples rather than limitations.

Hereafter, the high brightness blocks B of the successive time-sliced images F1, F2, F3, and F4 having a continuous corresponding variation relationship means that a relative position, relative brightness, a block size, or a combination thereof of the high brightness block B has a continuous corresponding variation. As shown in FIG. 3, there are continuous corresponding variations of relative positions and blocks sizes of the high brightness blocks B in the successive time-sliced images F1, F2, F3, and F4. The object determining unit 40 may further generate and output relative position information according to the continuous corresponding variations of the high brightness blocks B of the successive time-sliced images F1, F2, F3, and F4.

Further referring to FIG. 1 and FIG. 2, the apparatus 1 for monitoring an object in a low light environment further includes a grayscale conversion unit 50. The grayscale conversion unit 50 is communicably connected to the image capturing unit 10 and the image recognizing unit 30. The grayscale conversion unit 50 receives the time-sliced images F, converts each of the time-sliced images F into a grayscale time-sliced image, and outputs the grayscale time-sliced image to the image recognizing unit 30. The image recognizing unit 30 recognizes and marks a high brightness regions B according to the grayscale time-sliced image of each of the time-sliced images F. Herein, with regard to the brightness determining on the time-sliced images F, pixel brightness of three original colors R, G, and B is converted into grayscale values for determining. By means of grayscale conversion, determining on values can be simpler. Further, the grayscale conversion unit 50 can further remove noise from the grayscale time-sliced image according to a signal-to-noise ratio, so as to further focus on determining on the high brightness block B. In this way, light rays caused by reflection and refraction can be prevented from causing mistaken determining. Herein, the threshold may be a preset value of the grayscale, for example, ranging from 180 to 255. The threshold may also be calculated and set by means of regression analysis. Herein, the above are merely examples rather than limitations.

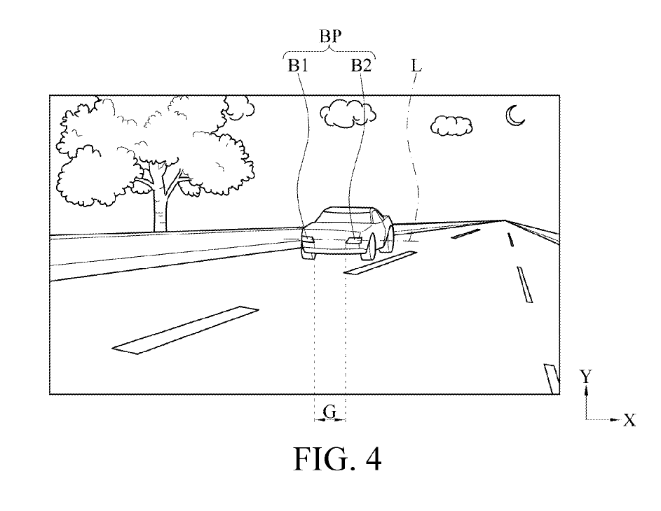

FIG. 4 is a schematic diagram of integrating two adjacent high brightness blocks into a pair of high brightness blocks. As shown in FIG. 4, referring to FIG. 2 and FIG. 3 together, when the image recognition unit 30 recognizes and marks at least two of the successive time-sliced images F1, F2, F3, and F4 respectively including two adjacent high brightness blocks B1 and B2, and the object determining unit 40 further determines that there is a transverse spacing G between the two adjacent high brightness blocks B1 and B2, and when the two adjacent high brightness blocks B1 and B2 transversely continuously correspondingly vary among the successive time-sliced images F1, F2, F3, and F4, and pairs and integrates the two adjacent high brightness blocks B1 and B2 into a pair of high brightness blocks BP. In FIG. 4, the transverse spacing G is on a horizontal line L, and a distance between the two adjacent high brightness blocks B1 and B2 is used as an example. However, the above are merely examples rather than limitations. Because relative distances between the two adjacent high brightness blocks B1 and B2 and the vehicle or lens flare may cause an angle deviation during image capturing, the word “transverse” in the transverse spacing G herein in the broad sense indicates that a component in a horizontal direction (that is, an X coordinate direction) is greater than a component in a vertical direction (that is, a Y coordinate direction). Meanwhile, a transverse continuous variation may indicate a variation having a component in a horizontal direction (that is, an X coordinate direction) greater than a component in a vertical direction (that is, a Y coordinate direction) of the two adjacent high brightness blocks B1 and B2 in the time-sliced images F, for example, a continuous corresponding variation of a relative position or a continuous corresponding variation of a block size. However, the above are merely examples rather than limitations.

Herein, at least two of the successive time-sliced images F1, F2, F3, and F4 respectively including two adjacent high brightness blocks B1 and B2 indicates that at least two of the successive time-sliced images F1, F2, F3, and F4 both include two adjacent high brightness blocks B1 and B2, and in the successive time-sliced images F1, F2, F3, and F4, the two adjacent high brightness blocks B1 and B2 mutually correspondingly and continuously vary.

On the contrary, if the two adjacent high brightness blocks B1 and B2 do not continuously correspondingly change, for example, the two adjacent high brightness blocks B1 and B2 have unequal estimated speed information, and the two adjacent high brightness blocks B1 and B2 have different moving directions, or when the two adjacent high brightness blocks B1 and B2 are vertically stacked, it is determined that the two adjacent high brightness blocks B1 and B2 are correspondingly two moving object blocks such as two motor cycles or two bicycles.

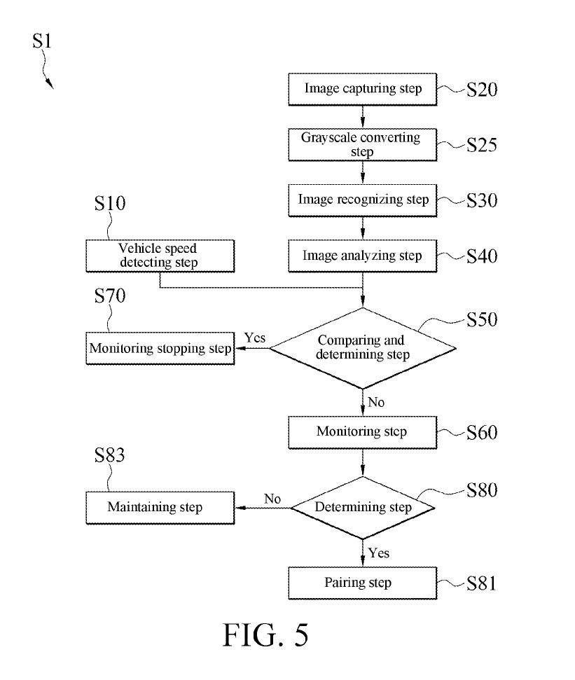

FIG. 5 is a flowchart of a method for monitoring an object in a low light environment. As shown in FIG. 5, a method S1 for monitoring an object in a low light environment includes a vehicle speed detecting step S10, an image capturing step S20, an image recognizing step S30, an image analyzing step S40, a comparing and determining step S50, a monitoring step S60, and a monitoring stopping step S70. FIG. 1 to FIG. 5 are referred to together below, and description is performed with reference to the relevant reference signs and the accompanying drawings.

The vehicle speed detecting step S10 is detecting current vehicle speed information and outputting the detected current vehicle speed information. The image capturing step S20 is continuously capturing a plurality of time-sliced images F. Herein, for the time-sliced images F, reference may be made to the time-sliced image F in FIG. 2, which is merely an example rather than a limitation herein. The image recognizing step S30 is performing image recognition to find a region having pixel brightness higher than a threshold in each of the time-sliced images F and marking the region as a high brightness block B.

The image analyzing step S40 is selecting by screening successive time-sliced images F1, F2, F3, and F4 having high brightness blocks B in a continuous corresponding variation relationship from the time-sliced images F and generating and outputting estimated speed information according to continuous corresponding variations of the high brightness blocks B of the successive time-sliced images F1, F2, F3, and F4. Further, relative distances of the high brightness blocks B are generated and output according to continuous corresponding variations of the high brightness blocks B of the successive time-sliced images F1, F2, F3, and F4. Herein, the vehicle speed detecting step S10 is not limited to being performed simultaneously with the image capturing step S20 or the image analyzing step S40.

The comparing and determining step S50 is performing comparison to determine whether the estimated speed information equals the current vehicle speed information, and if not, that is, the estimated speed information is different from the current vehicle speed information, determining that the high brightness block B is correspondingly a moving object block and outputting an estimated speed of the moving block, and then, the monitoring step S60 is performed. The monitoring step S60 is determining that the high brightness block B is a moving object block and continuously monitoring the moving object block and the estimated speed information corresponding thereto. Further, a relative distance of the moving object is continuously monitored and output. On the contrary, when a determining result is yes in the comparing and determining step S50, that is, the estimated speed information is different from the current vehicle speed information, it is determined that high brightness block B is a fixed object block, and the monitoring stopping step S70 is performed. The monitoring stopping step S70 is determining that the high brightness block B is a fixed object block and stopping the continuous monitoring. Herein, the step is performed in only an ordinary situation. In a special situation, for example, there is a fire, or a road warning is received, the fixed object block can still be continuously monitored.

Further, in the method S1 for monitoring an object a low light environment, the image recognizing step S30 may further include a grayscale converting step S25. The grayscale converting step S25 is after the image capturing step S20, performing grayscale conversion on the received time-sliced image F to obtain and output a grayscale time-sliced image, and the image recognizing step S30 is performing image recognition on each of the grayscale time-sliced images, to mark the high brightness block B. In this way, the determining of brightness may be performed by converting pixel brightness of three original colors R, G, and B into grayscale values for determining, so that setting of a threshold and determining of a value may be simpler. It is easier to determine whether the grayscale value is higher than a threshold, to perform further determining.

Further, referring to FIG. 1 to FIG. 5 together, in the image recognizing step S30, when it is determined that the successive time-sliced images F1, F2, F3, and F4 respectively have two adjacent high brightness blocks B1 and B2, the method S1 for monitoring an object in a low light environment may further include a determining step S80, a pairing step S81, and a maintaining step S83. The determining step S80 is determining whether there is a transverse spacing G between two adjacent high brightness blocks B1 and B2, and when the two adjacent high brightness blocks B1 and B2 transversely continuously vary among the successive time-sliced images F1, F2, F3, and F4, if yes, the pairing step S81 is performed, to pair and integrate the two adjacent high brightness blocks B1 and B2 into a pair of high brightness blocks BP. If not, the maintaining step S83 is performed, to maintain the two adjacent high brightness blocks B1 and B2 as two high brightness blocks B1 and B2, that is, corresponding to two moving object blocks.

As described in the foregoing embodiments, by capturing a high brightness block in a time-sliced image, existing visual monitoring may be replaced by light monitoring at night or in a dim light, or the light monitoring may be cooperated with the visual monitoring to produce an effect of helping monitoring and determining all day. In a dim light, an environment around a vehicle may be controlled and managed by determining a high brightness block in an image, meanwhile, a moving object nearby the vehicle can be monitored, and a traffic condition around the vehicle is determined in real time, to keep vehicle driving safety.

Certainly, the present invention may further include various other embodiments. A person of ordinary skill in the art may make various corresponding modifications and deformations according to the present invention without departing from the spirit and essence of the present invention. However, the corresponding modifications and deformations should all fall within the protection scope of the claims appended to the present invention.

What is claimed is:

1. An apparatus for monitoring an object in a low light environment, comprising:
an image capturing unit continuously for capturing and outputting a plurality of time-sliced images;
a vehicle speed unit for detecting and outputting current vehicle speed information;
an image recognizing unit communicably connected to the image capturing unit for receiving the plurality of time-sliced images, wherein the image recognizing unit recognizes a region having pixel brightness higher than a threshold in each of the time-sliced images and marks the region as a high brightness block; and
an object determining unit communicably connected to the vehicle speed unit and the image recognizing unit for receiving the current vehicle speed information and the high brightness blocks of the plurality of time-sliced images, wherein the object determining unit selects at least two successive time-sliced images having the high brightness blocks in a continuous corresponding variation relationship from the plurality of time-sliced images, and generates and outputs estimated speed information according to continuous corresponding variations of the high brightness blocks of the two successive time-sliced images, and when the estimated speed information is different from the current vehicle speed information, the object determining unit determines that the high brightness block is correspondingly a moving object block.

2. The apparatus for monitoring an object in a low light environment of claim 1, wherein the object determining unit determines that the high brightness block is correspondingly a fixed object block when the estimated speed information equals the current vehicle speed information.

3. The apparatus for monitoring an object in a low light environment of claim 1, wherein each of the time-sliced images comprises a sky image, a road image, and a ground image, the road image is between the sky image and the ground image, and the image recognizing unit recognizes a region having pixel brightness higher than the threshold in the road image of each of the time-sliced images and marks the region as the high brightness block.

4. The apparatus for monitoring an object in a low light environment of claim 3, wherein the road image of each of the time-sliced images comprises a central image and an inner-side image, the central image is adjacent to a side of the inner-side image, and the image recognizing unit recognizes a region having pixel brightness higher than the threshold in the central image of each of the time-sliced images and marks the region as the high brightness block.

5. The apparatus for monitoring an object in a low light environment of claim 4, wherein the road image of each of the time-sliced images further comprises an outer-side image, the outer-side image is adjacent to one side of the central image and is opposite to the inner-side image, and the image recognizing unit further recognizes a region having pixel brightness higher than the threshold in the outer-side image of each of the time-sliced images and marks the region as the high brightness block.

6. The apparatus for monitoring an object in a low light environment of claim 1, further comprising a grayscale conversion unit, wherein the grayscale conversion unit is communicably connected to the image capturing unit and the image recognizing unit, the grayscale conversion unit receives the plurality of time-sliced images, converts each of the time-sliced images into a grayscale time-sliced image, and further outputs the grayscale time-sliced image to the image recognizing unit, and the image recognizing unit recognizes and marks the high brightness block according to each of the grayscale time-sliced images.

7. The apparatus for monitoring an object in a low light environment of claim 1, wherein the two successive time-sliced images respectively comprise two adjacent high brightness blocks, and the object determining unit further determines that there is a transverse spacing between the two adjacent high brightness blocks, and when the two adjacent high brightness blocks transversely continuously correspondingly vary between the at least two successive time-sliced images, the two adjacent high brightness blocks are paired and integrated into a pair of high brightness blocks.

8. The apparatus for monitoring an object in a low light environment of claim 1, wherein the high brightness blocks of the two successive time-sliced images having a continuous corresponding variation relationship means that a relative position, relative brightness, a block size, or a combination thereof of each of the high brightness blocks has a continuous corresponding variation.

9. The apparatus for monitoring an object in a low light environment of claim 1, wherein the object determining unit further generates and outputs relative position information according to continuous corresponding variations of the high brightness blocks of the two successive time-sliced images.

10. A method for monitoring an object in a low light environment, comprising the following steps:
an image capturing step: continuously capturing a plurality of time-sliced images;
an image recognizing step: recognizing the time-sliced images to find a region having pixel brightness higher than a threshold in each of the time-sliced images and marking the region as a high brightness block;
an image analyzing step: selecting by screening at least two successive time-sliced images having the high brightness blocks in a continuous corresponding variation relationship from the plurality of time-sliced images and generating and outputting estimated speed information according to continuous corresponding variations of the high brightness blocks of the two successive time-sliced images;
a comparing and determining step: comparing the estimated speed information with current vehicle speed information, and when the estimated speed information is different from the current vehicle speed information, determining that the high brightness block is correspondingly a moving object block; and
a monitoring step, continuously monitoring the moving object block and the estimated speed information corresponding thereto.

11. The method for monitoring an object in a low light environment of claim 10, wherein when the estimated speed information equals the current vehicle speed information, it is determined that the high brightness block is a fixed object block, and the monitoring is stopped.

12. The method for monitoring an object in a low light environment of claim 10, wherein each of the time-sliced images comprises a sky image, a road image, and a ground image, the road image is between the sky image and the ground image, and the image recognizing step is performing image recognition to find a region having pixel brightness higher than the threshold in the road image of each of the time-sliced images and marking the region as the high brightness block.

13. The method for monitoring an object in a low light environment of claim 12, wherein the road image of each of the time-sliced images comprises a central image and an inner-side image, the central image is adjacent to a side of the inner-side image, and the image recognizing step is performing image recognition to find a region having pixel brightness higher than the threshold in the central image of each of the time-sliced images and marking the region as the high brightness block.

14. The method for monitoring an object in a low light environment of claim 13, wherein the road image of each of the time-sliced images further comprises an outer-side image, the outer-side image is adjacent to a side of the central image and is opposite to the inner-side image, and the image recognizing step is further performing image recognition to find a region having pixel brightness higher than the threshold in the outer-side image of each of the time-sliced images and marking the region as the high brightness block.

15. The method for monitoring an object in a low light environment of claim 10, wherein the image recognizing step comprises a grayscale converting step, wherein
grayscale conversion is performed on each of the time-sliced images to obtain and output a grayscale time-sliced image; and
image recognition is to find a region having pixel brightness higher than the threshold in each of the grayscale time-sliced image, and to mark the region as a high brightness block.

16. The method for monitoring an object in a low light environment of claim 10, wherein when it is marked that the two successive time-sliced images respectively have two adjacent high brightness blocks, the image recognizing step further comprises:
a determining step: determining that there is a transverse spacing between the two adjacent high brightness blocks and the two adjacent high brightness blocks transversely continuously correspondingly vary between the two successive time-sliced images; and
a pairing step: pairing and integrating the two adjacent high brightness blocks into a pair of high brightness blocks.

17. The method for monitoring an object in a low light environment of claim 10, wherein the two successive time-sliced images having the high brightness blocks in a continuous corresponding variation relationship means that a relative position, relative brightness, a block size, or a combination thereof of each of the high brightness blocks has a continuous corresponding variation.

18. The method for monitoring an object in a low light environment of claim 10, further comprising the following step: generating and outputting relative position information according to continuous corresponding variations of the high brightness blocks of the two successive time-sliced images and continuously monitoring the relative position information.
